(19) United States
(12) Patent Application Publication
(10) Pub. No.: US 2010/0019683 A1
(43) Pub. Date: Jan. 28, 2010

(54) METHOD AND DEVICE FOR DRIVING A GAS DISCHARGE LAMP

(75) Inventor: Rob Otte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,429

(22) PCT Filed: Dec. 17, 2007
(86) PCT No.: PCT/IB07/55153

§ 371 Date: Jun. 16, 2009

(30) Foreign Application Priority Data
Dec. 22, 2006 (EP) 06127019.5

(51) Int. Cl. H05B 41/288; H05B 41/36

(52) U.S. Cl. 315/224; 315/246

(57) ABSTRACT

A method is described for driving a gas discharge lamp (11) with commutating lamp current, wherein the lamp current has an average commutation frequency (1/T0), the lamp current preferably having constant magnitude. In order to counteract the excitation of acoustic resonances, the phase (C) of the commutation moments is randomly modulated.

### FIELD OF THE INVENTION

The present invention relates in general to a method and device for driving a gas discharge lamp, using an alternating lamp current. The present invention relates specifically to the driving of a High Intensity Discharge lamp (HID), i.e. a high-pressure lamp, such as for instance a high-pressure sodium lamp, a high-pressure mercury lamp, a metal-halide lamp. In the following, the invention will be specifically explained for a HID lamp, but application of the invention is not restricted to a HID lamp, as the invention can be more generally applied to other types of gas discharge lamps.

### BACKGROUND OF THE INVENTION

Gas discharge lamps are known in the art, so an elaborate explanation of gas discharge lamps is not needed here. Suffice it to say that a gas discharge lamp comprises two electrodes located in a closed vessel filled with an ionizable gas or vapor. The vessel is typically quartz or a ceramic, specifically polychrystalline alumina (PCA). The electrodes are arranged at a certain distance from each other, and during operation an electric arc is maintained between those electrodes.

An important problem of gas discharge lamps is the possibility of acoustic resonances, i.e. pressure resonances, occurring generally in the range from 9 kHz to 1 MHz, and this problem is particularly serious in the case of HID lamps. As a result of acoustic resonances, the behavior of the arc becomes unpredictable, and possibly unstable; the arc can touch the vessel, damaging the vessel, and the arc can extinguish. Also, acoustic resonances in the audible frequency range may lead to audible noise, which is annoying. Acoustic resonances involve resonant pressure variations, and an important source of pressure variations are power variations: if the lamp power varies, power dissipation in the arc varies, causing variation in the generated heat and hence in the pressure. Thus, it is desirable to operate the lamp with constant power.

One obvious way of operating a discharge lamp with constant power is DC operation. However, DC operation also involves some disadvantages, including asymmetric erosion of the electrodes. In order to avoid these disadvantages, it is known to operate a discharge lamp with commutating DC current, i.e. a lamp current which has constant magnitude but alternating direction.

Ideally, current commutation (i.e. change of current direction) is instantaneous, but in practice the current magnitude decreases to zero and then increases in the opposite direction within a non-zero time interval. This leads to power dips having the commutation frequency, and such power variations, as explained above, may lead to resonances.

Normally, gas discharge lamps are operated with a current frequency in the order of 100 Hz, but there is a tendency to explore operating gas discharge lamps with a higher current frequency, because this may allow the use of smaller circuit components and hence reduced costs. This increases the risk of encountering acoustic resonance frequencies. A problem in this respect is the fact that, although the higher frequency range has resonance-free regions, the resonance frequencies may vary from lamp to lamp and may vary with time, so it is very difficult or even impossible to select a specific operating frequency that at all times will be a safe, resonance-free operating frequency for all lamps. Further, when the current frequency is increased, the current period is decreased. On the other hand, the duration of the non-zero commutation interval will not scale with the current period; thus, in relation to the current period, the commutation intervals gain weight and the corresponding pressure variations become more serious.

It would be advantageous if the lamp driver is of the Half-Bridge Commutating Forward (HBCF) design, because such circuits are well available and have relatively low cost. In such design, however, a commutating direct current is generated with a relatively large current ripple, so such driver comprises a capacitor parallel to the lamp, which capacitor must be relatively large in order to reduce such ripple. On the other hand, the time needed for commutation at least partly depends on this capacitor, larger capacitance causing longer commutation times.

### SUMMARY OF THE INVENTION

An object of the present invention is to eliminate or at least reduce the above-mentioned problems.

Specifically, an object of the present invention is to provide a method for driving gas discharge lamps with commutating lamp current, and a lamp driver for performing the method, such that the probability of acoustic resonances being induced by current commutation is reduced.

According to an important aspect of the present invention, the commutation moments are randomized. As a result, the pressure variations induced by commutation are no longer periodic with one specific frequency but they are spread out in a frequency range, while the power contribution at single frequencies is substantially reduced.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating a lamp driver;

FIGS. 2A-D are time diagrams schematically showing the lamp current and lamp power as a function of time in different circumstances;

FIG. 3 is a graph showing Fourier coefficients;

FIG. 4A is a block diagram schematically illustrating a lamp driver according to the present invention;

FIG. 4B is a time diagram schematically illustrating lamp operation according to the present invention;

FIGS. 5A-C illustrate an energy spectrum;

FIGS. 6A-B illustrate an energy spectrum.

FIG. 7 is a block diagram schematically illustrating a lamp driver according to the present invention.

### DETAILED DESCRIPTION OF THE INVENTION

In the following, the present invention will be specifically explained for the case of a lamp driver of the HBCF-type, but it is noted that the present invention is not limited to drivers of this design since applying the invention to other driver types also provides advantages.

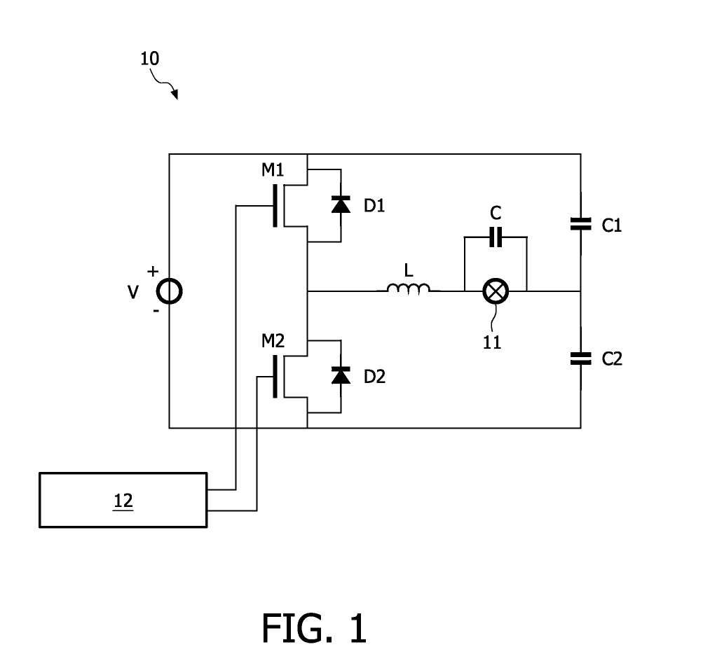

FIG. 1 is a block diagram schematically illustrating an exemplary lamp driver 10 for driving a gas discharge lamp 11 in accordance with prior art. This lamp driver 10 has a half-bridge commutating forward design, which should be known to persons skilled in the art. Two switches M1 and M2 are arranged in series, with corresponding diodes D1, D2, between two voltage rails coupled to a source of substantially constant voltage V. The design of this voltage source is not relevant for the present invention. Two capacitors C1 and C2 are also arranged in series between the two voltage rails. The lamp 11 is coupled between on the one hand the junction between the two switches M1 and M2 and on the other hand the junction between the two capacitors C1 and C2, with an inductor L arranged in series with the lamp 11 and a capacitor C arranged in parallel with the lamp 11. The two switches M1 and M2 are controlled alternately by a controller 12, such that they are never closed (i.e. conductive) at the same time, as follows.

In a first half of the current period, the lower switch M2 is open (i.e. non-conductive) and the upper switch M1 is switched open and closed at a relatively high frequency. The lamp current has a first direction; when the upper switch M1 is closed, the current magnitude increases, and when the upper switch M1 is open the current magnitude decreases, so that the lamp current I has a DC average and a high-frequency ripple. The size of the ripple depends on the size of capacitor C: for smaller ripple, the capacitance value must be higher.

In a second half of the current period, the upper switch M1 is open (i.e. non-conductive) and the lower switch M2 is switched open and closed at the relatively high frequency. The lamp current has a second direction opposite to the first direction; when the lower switch M2 is closed, the current magnitude increases, and when the lower switch M2 is open the current magnitude decreases, so that the lamp current I has a DC average and a high-frequency ripple. The size of this ripple also depends on the size of capacitor C. On transition from the first half of the current period to the second half of the current period, the current must change from a current flowing from the inductor L towards the second capacitor C2 to a current flowing from the first capacitor C1 towards the inductor L. This means that the current direction through said capacitor C reverses, i.e. this capacitor must be discharged and charged in the opposite direction. The time needed for this commutation depends on the size of the coil and the capacitor C: for reduced commutation time, the capacitance value must be lower.

Thus, there are two mutually conflicting requirements for the capacitor C, i.e. a requirement for increased size in order to reduce ripple and a requirement for decreased size in order to reduce commutation time. The capacitor size eventually selected will involve a trade-off between ripple size and commutation time. According to the invention, the commutation moments are randomized, as will be explained later, and as a result the influence of the commutation on triggering possible resonances is reduced, thus allowing the size of the capacitor C to be increased in order to reduce ripple.

The actual effect of randomizing the commutation moments depend on several factors, particularly the waveform of the current during commutation, which in turn is largely determined by the hardware components of the driver, and even the switching characteristics of the switches M1 and M2, so that, for a given driver, the power dip contour is to be considered as a constant apparatus property. In practice, it will be very difficult or even impossible to manipulate the shape of the commutation waveform at will. In the following, some models will be given, which all are approximations of the real time-contour of actual power dips to some extent, and the conclusion will be drawn that in all practical circumstances the inventive concept offers an improvement.

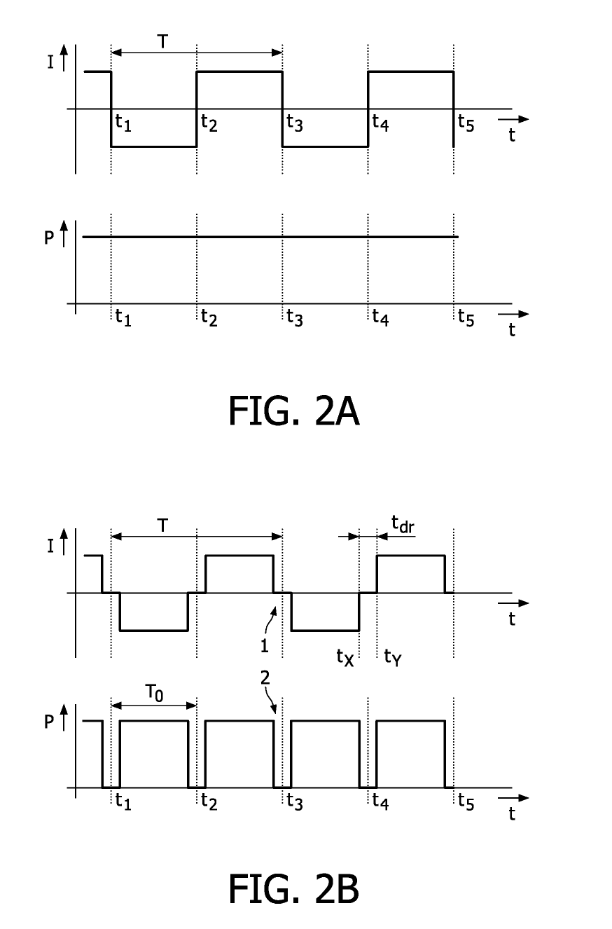

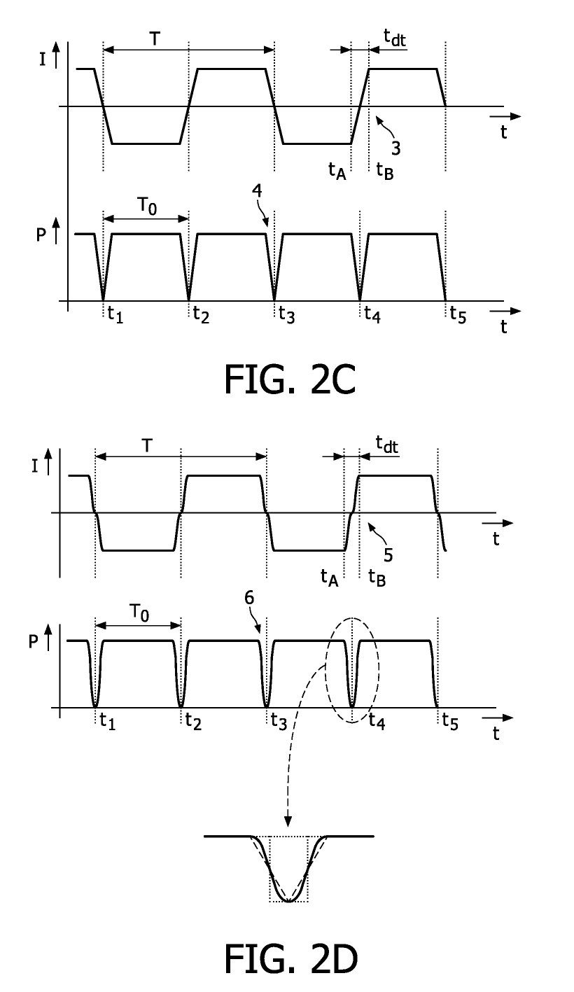

FIG. 2A schematically shows lamp current (upper graph) and corresponding lamp power (lower graph) as a function of time for a lamp being operated with commutating current. The lamp current I has constant magnitude (the current ripple is ignored in this figure), but changes direction at commutation moments t₁, t₂, t₃, t₄, t₅. In this figure, the commutation is ideal, i.e. occurs infinitely fast in zero time, thus the lamp power P is constant. The current period is indicated as T. In practice, however, in view of the non-zero values of the inductivity of the inductor L and the capacitance of the capacitor C, commutation is not ideal but will require a non-zero commutation time, as will be explained using the following models.

FIG. 2B schematically illustrates a model which describes the lamp current as dropping to zero infinitely fast and rising from zero infinitely fast, but there is a small delay time t_{d} between the current dropping to zero (for instance at time t_{X}) and the current rising to the opposite direction (for instance at time t_{Y}). A commutation interval is indicated at 1. The lower graph of FIG. 2B shows the resulting lamp power P. Outside the commutation intervals, the lamp power P is constant; corresponding with the commutation intervals, the lamp power P shows rectangular power dips 2 of duration t_{dr}; these dips obviously have a dip repetition period T₀=T/2.

FIG. 2C schematically shows a more realistic model of the commutation, where the current magnitude decreases to zero according to a linear function of time, crosses zero, and immediately rises in the opposite direction in a linear function of time, such that the time-derivative of the current is constant during the commutation interval 3 from t_{A} to t_{B}. Again, the commutation interval 3 has a duration defined as t_{d}=t_{B}−t_{A}. Corresponding with the commutation intervals, the lamp power P shows power dips 4 having the same dip repetition period T₀=T/2, but the power dips 4 now have a triangular shape.

FIG. 2D schematically shows a still more realistic model of the commutation, where the current magnitude decreases at an increasing speed and then approaches zero with a decreasing speed, crosses zero, and rises in the opposite direction with increasing speed and then approaches the nominal current level with a decreasing speed, such that, during the commutation interval 5 from t_{A} to t_{B}, the lamp power P shows a power dip 6 having a cosine-shape.

It is noted that the power dips 2, 4, 6 represent energy, the amount of energy corresponding to the surface area of the respective dips. If the durations t_{d} of the power dips 2, 4, 6 are mutually equal, the energy content of the rectangular power dip 2 is twice as large as the energy content of the triangular power dip 4 and the cosine-shaped dip 6. For allowing a comparison with mutually equal energy contents in the following, a power dip duration will be defined for each power dip shape such that the energy content is always the same, which energy contents will be referred to as “commutation energy” E_{C}. For the models described above, this means that the duration t_{dt} of the triangular power dip 4 is equal to the duration t_{dc} of the cosine-shaped power dip 6 and twice as long as the duration t_{dr} of the rectangular power dip 2, as illustrated in the enlargement of FIG. 2D. For the following discussion, the power dip duration will be defined in relation to the commutation repetition period T₀ according to t_{dc}=t_{dr}=t_{dt}/2=T₀/L, L being an integer. Further, in view of the fact that these power dips are caused by commutation, they will hereinafter also be indicated by the phrase “commutation dip”.

It is further noted that other models with other shapes for approximating the contour of the commutation dips are also possible, but this will have little influence on the outcome of the next discussion.

The commutation dips 2, 4, 6 are periodical with dip period T₀=T/2. Their spectral contents can be determined by considering the power P as a function of time P(t), and by developing this periodical function as a Fourier series according to the following formula:

$$P ( t ) = {\sum }_{n = - ∞}^{∞} {c}_{n} {e}^{j n 2 π \frac{t}{{T}_{0}}}$$

$$with$$

$${c}_{n} = \frac{1}{{T}_{0}} {\int }_{- \frac{{T}_{0}}{2}}^{\frac{{T}_{0}}{2}} P ( t ) {e}^{- j n 2 π \frac{t}{{T}_{0}}} d t$$

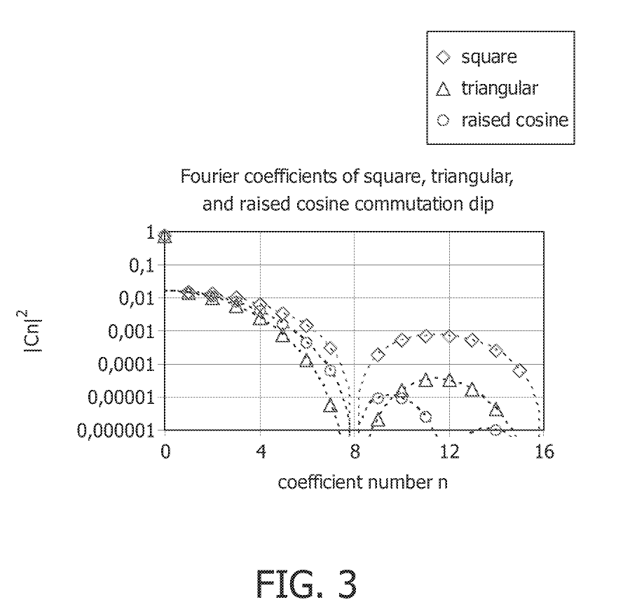

The coefficients cₙ relate to the frequencies n/T₀, n being an integer. FIG. 3 is a graph showing these coefficients cₙ for t_{dc}=t_{dr}=t_{dt}/2=T₀/8, while the lamp power P is normalized to P=1 W for sake of convenience. Square points indicate coefficients for rectangular power dips 2, triangular points indicate coefficients for triangular power dips 4, and circular points indicate coefficients for cosine-shaped power dips 6. For the rectangular power dips 2, |c₁|=0.015 and |c₂|=0.013. For the triangular power dips 4 and the cosine-shaped power dips 6, the coefficients are only marginally smaller. This means that smoothing the shape of the commutation dip as compared to the worst-case shape (rectangular) does not strongly reduce the magnitude of the strongest coefficients.

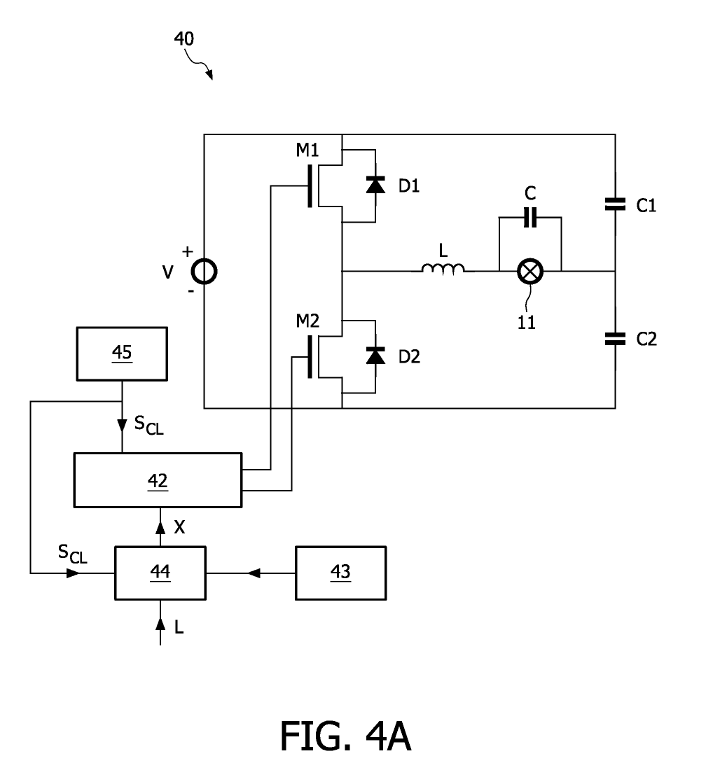

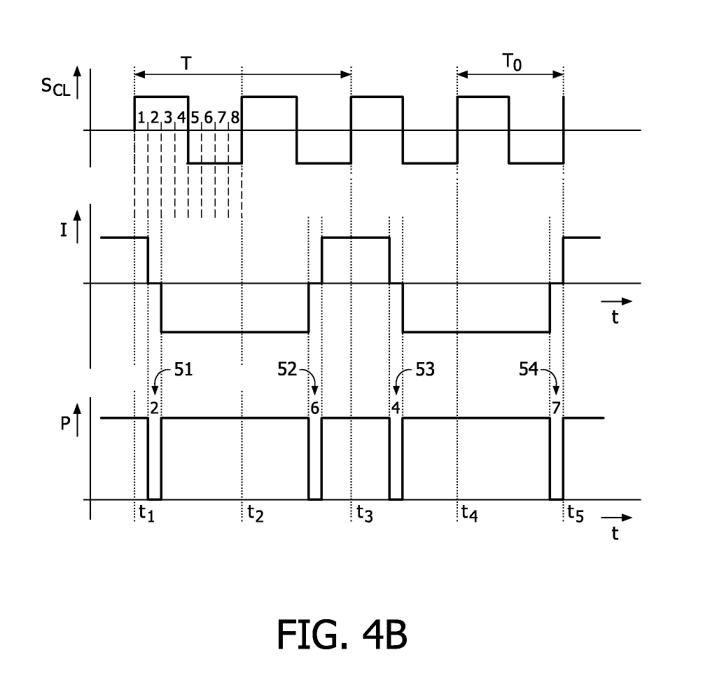

The above applies when the commutation dips occur exactly with repetition period T₀. According to the invention, the commutation moments are randomly modulated around the repetition period T₀, i.e. a random phase modulation of the commutation moments, as will be explained with reference to FIGS. 4A and 4B.

FIG. 4A is a diagram, comparable to FIG. 1, of a driver 40 according to the present invention, and FIG. 4B shows graphs comparable to FIG. 2B of the lamp current I (middle graph) occurring in the lamp 11. FIG. 4B also shows an exemplary clock signal S_{CL}, that defines a time base, and that is generated by a clock signal generator 45. FIG. 4A shows the clock signal generator 45 as being external to the controller 42, but it is noted that the clock signal generator 45 may also be an integral component of the controller 42.

The clock signal S_{CL} defines consecutive time cells of equal duration T₀. In the example shown, the cell boundaries coincide with rising edges of the clock signal S_{CL}. It is noted that the operation of system 10 of FIG. 1, as illustrated in FIGS. 2A-2D, would be obtained if commutation would coincide with, or be triggered by, the rising edges of the clock signal S_{CL}. In such case, the location of a commutation dip within the time cells would always be the same, and the commutation dips would be precisely periodical. According to the present invention, however, the location of a commutation dip within the time cells varies at random. The variation may be continuous, but the variation may also be discrete, meaning that a time cell has a predetermined number L of possible locations for a commutation dip, which corresponds to a predetermined number of possible moments for commutation to start; these moments will be indicated as commutation phase φ_{C} Further, the probability of all possible positions are mutually substantially equal.

This method of operation according to the present invention is illustrated in FIG. 4B for rectangular commutation dips, but a comparable explanation would apply for the model of triangular commutation dips, or for any other shape of the commutation dips. In FIG. 4B, the predetermined number L of possible locations for a commutation dip is equal to 8, but it should be clear that this number is chosen only by way of illustrative example. Preferably, L is chosen in accordance with the following formula: L=T₀/t_{d}, or at least approximately. Conversely, one may consider the time cells to be subdivided into L time segments of equal duration Δ=T₀/L, so that in the preferred embodiment Δ=t_{d} applies.

FIG. 4B shows that in a first time cell starting at time t₁, the commutation dip 51 is located in the second time segment;

in a second time cell starting at time t₂, the commutation dip 52 is located in the sixth time segment;

in a third time cell starting at time t₃, the commutation dip 53 is located in the fourth time segment;

in a fourth time cell starting at time t₄, the commutation dip 54 is located in the seventh time segment.

For performing the above operation, driver 40 comprises a random generator 43 and a phase modulator 44, which may, as illustrated, be external to the controller 42 but which may also be integral parts of the controller 42. The number of possible positions L may be a predetermined fixed number, but it is also possible that the phase modulator 44 has an input for receiving the choice of L as an input signal. Alternatively, it is possible that the phase modulator 44 has an input for receiving the duration A of the cell segments as an input signal.

In operation, the phase modulator 44 generates a phase signal X for the controller 42, which phase signal X indicates the value of the commutation phase φ_{C} in the next time cell. Illustratively, the phase signal X may indicate an integer in the range [1; L]. For synchronisation with the time cells, the phase modulator 44 may receive the clock signal S_{CL}, as illustrated. For instance, the phase modulator 44 may be triggered by the falling edges of the clock signal S_{CL} to generate a new value for its phase signal X.

On receiving a rising edge of the clock signal S_{CL}, the controller 42 waits a delay time t_{DELAY} calculated according to t_{DELAY}=(X−1)·Δ to skip (X−1) cell segments, and then starts performing a commutation operation, so that the commutation dip is located in the Xth cell segment. In a continuous operation, t_{DELAY} may have any value between zero and T₀−Δ. It is noted that the phase φ_{C} of the start of the commutation is given by φ_{C}=t_{DELAY}/T₀, the phase ranging from 0 to 1 in a time cell.

Since each time cell contains a commutation moment, the average commutation period would still be T₀, but in individual cases the time between consecutive commutation dips may be more than T₀ (as between dips 51 and 52) or less than T₀ (as between dips 52 and 53).

When the actual commutation moments are randomly modulated with average repetition period T₀, i.e. a random phase modulation of the commutation moments, the energy spectrum (in W²/Hz) of the commutation dips (considered as constituting energy pulses) can be expressed by the following formulas:

$$S ( f ) = {P}^{2} {\vert V ( f ) \vert}^{2} \{ {S}_{1} ( f ) + {S}_{2 } ( f ) \}$$

$$with$$

$${S}_{1} ( f ) - \frac{1}{{T}_{0}} [ \frac{L - 1}{L} + \frac{2}{L} {\sum }_{k = 1}^{L - 1} \frac{k - L}{L} cos ( k 2 π \frac{{T}_{0}}{L} ) ]$$

$$and$$

$${S}_{2} ( f ) = \frac{1}{{T}_{0}^{2}} {\sum }_{k = - ∞}^{∞} δ ( f - \frac{kL}{{T}_{0}} )$$

in which S₁(f) describes the continuous part of the random phase modulation and S₂(f) describes the discrete part. The factor |V(f)|² accounts for the shape of the pulses.

Obviously, in S(f) discrete frequencies at f=L/T₀ and its multiples may be present but need not be present. This situation is different from the original case without modulation, where the discrete frequencies were always present and occurred at f=1/T₀ and its multiples.

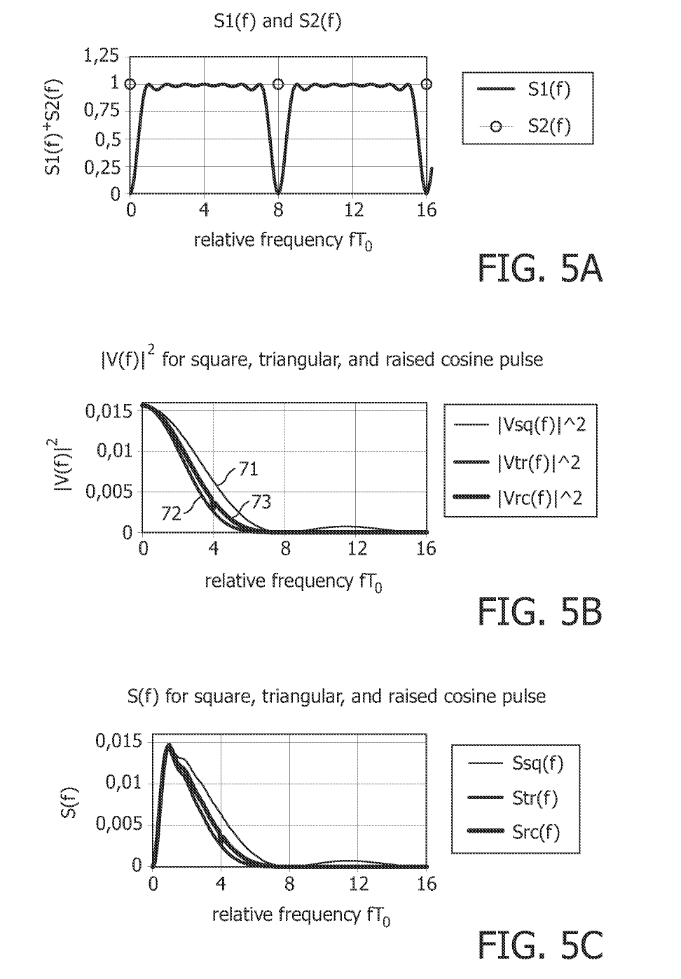

FIG. 5A is a graph showing the functions S₁(f) (continuous curve) and S₂(f) (discrete points) as a function of the relative frequency fT₀, for L=8. Typically, S₁(f) is equal to zero for fT₀=n·L, n being an integer, while the discrete contributions of S₂(f) just appear at these locations.

FIG. 5B is a graph showing the function |V(f)|² as a function of the relative frequency fT₀, for L=8, for the examples of the rectangular dips (curve 71), triangular dips (curve 72), and cosine-shaped dips (curve 73). It appears that, for these examples, |V(f)|² is equal to zero for fT₀=n·L, thus masking the discrete contributions of S₂(f) except at f=0, which corresponds to the DC component which is not further considered here as it does not give rise to resonances.

The corresponding function S(f), obtained by multiplying S₁(f)+S₂(f) illustrated in FIG. 5A and |V(f)|² illustrated in FIG. 5B, is shown in the graph of FIG. 5C, for frequencies larger than zero. It can be seen that S(f) is a continuous function in this case, i.e. without discrete contributions. From the figure, it can further be seen that smoothing the shape of the commutation dip does not have a large impact on the frequency spectrum for fT₀<L. At about fT₀≈1.5·L, the case of the rectangular dips shows a small maximum which can not be seen in the other two cases.

In an example with T₀=40 μs, power dip duration 5 μs, and L=8, we find for the unmodulated case the first Fourier coefficient at 25 kHz as |C₁|²=0.015 for rectangular dips. Still for rectangular dips, if the commutation moments are randomly modulated, the spectrum is continuous, with the maximum still at 25 kHz. However, if we calculate power variation in 100 Hz bandwidth (which is a reasonable estimate of the bandwidth of a lamp resonance), it appears to be about 250 times smaller. This is because most of the power ripple has been moved out of the resonance band. Thus, the risk of resonance has been reduced without specific knowledge of the frequency of resonance.

For arbitrary dip shapes, the masking of S₂(f) by the zeros of |V(f)|² does not necessarily occur because |V(f)|² does not necessarily have the required zeros at the right frequencies. From the theory of Nyquist, it is known that the criterion for these zeros to be present is that of point symmetry of the sides of the pulse around the respective midpoints of those sides (and the requirement T_{comm}=T₀/L, with T_{comm} indicating the power dip duration or commutation time). This symmetry is also called vestigial symmetry and a pulse with this property is called Nyquist pulse.

In general practice, the commutation dips may not show such Nyquist shape. Nevertheless, even in such case it is possible to optimize L to achieve significant suppression of the discrete components of S₂(f).

Firstly, it is possible to simply choose a large value of L. Then, the discrete frequency components of S₂(f) are at high frequency, so quite far in the tails of |V(f)|². Therefore they are strongly suppressed. This is especially true if the dip has a smooth shape like the raised cosine shape.

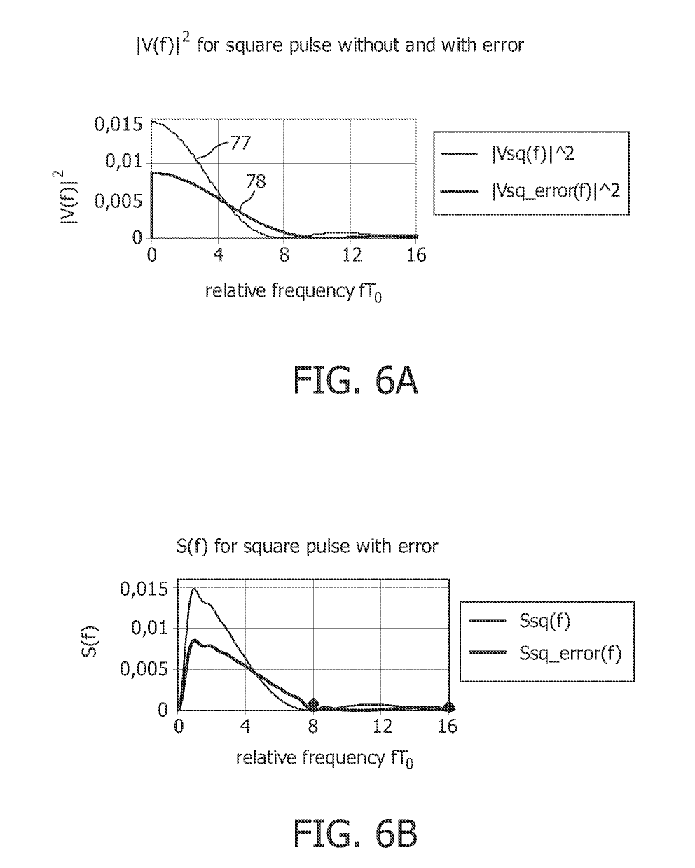

Secondly, an approximation is possible by estimating the width of the dip as <T_{comm}> and choosing L according to L=T₀/<T_{comm}>. The suppression will not be perfect, but in many cases still good enough. This is demonstrated by the example below, in which the pulse shape is deliberately chosen to be suboptimal. The commutation dip is assumed to have a rectangular shape (worst case), and the duration is deliberately taken to be too small by 25%. FIG. 6A is a graph comparable to FIG. 5B, showing the spectra |V(f)|² of the original, correct dip (curve 77) and the erroneous dip curve 78). Obviously, there is no complete suppression of S₂(f) anymore. The influence on S(f) is shown in FIG. 6B, which is a graph comparable to FIG. 5C. It can clearly be seen that the large deviation from the optimal shape results in small discrete frequency components being present again (shown as ‘diamonds’ in the figure). However, if for this case the first harmonic is calculated and compared to the first harmonic of the unmodulated case (FIG. 3), the following is found:

1) the first harmonic is located at a frequency L times higher (here 8), and

2) the first harmonic is much weaker (here about 20×).

3) Also, the number of harmonics is lower.

So even in case of a quite suboptimal shape of the dip, an improvement is achieved. It is noted that in practice a deviation as discussed is unlikely, so it is reasonable to assume that this conclusion is valid for practically any practical pulse shape and properly chosen value of L.

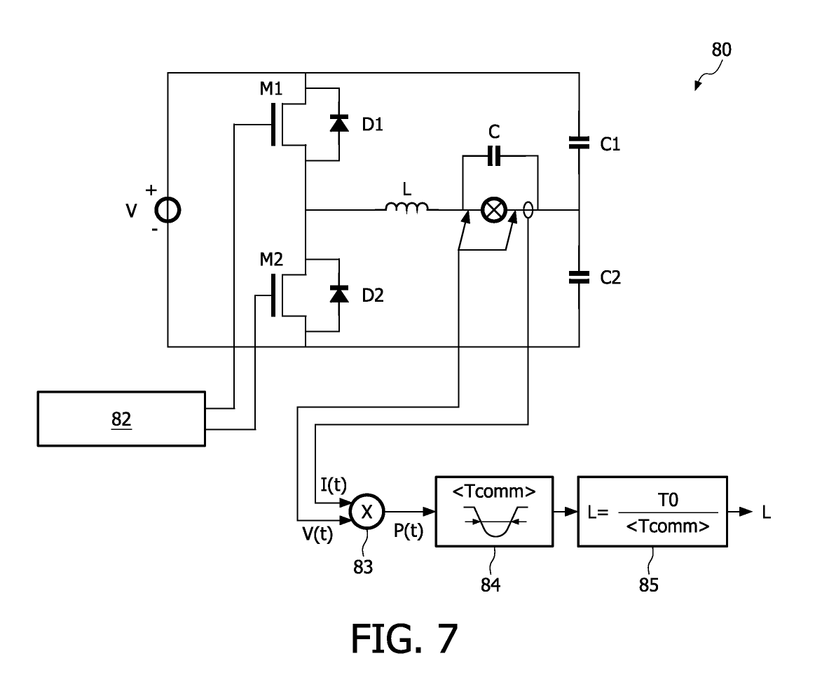

FIG. 7 is a diagram, comparable to FIG. 1, of a driver 80 according to the present invention, comprising a switch controller 82, which is provided with a random generator functionality, which may be external to the controller 82 but which may also be integral part of the controller 82. (For sake of simplicity, components such as a clock generator 45 and a phase modulator 44 are not shown in this figure). A multiplier 83 receives a lamp voltage signal V(t) from a lamp voltage sensor and receives a lamp current signal I(t) from a lamp current sensor, and calculates a lamp power signal P(t)=V(t)·I(t). From this lamp power signal P(t), an estimator 84 estimates a value <T_{comm}> for the duration of the commutation dips. A calculating block 85 calculates L according to L=T₀/T_{comm}. This value L is provided to the controller 82. It is noted that the multiplier 83 and/or estimator 84 and/or calculating block 85 may be separate but may also be integral part of the controller 82. The estimator 84 may estimate the value <T_{comm}> by taking the width of the pulses at the half height thereof. It is also possible that the estimator 84 may estimate the value <T_{comm}> by taking the area of the dip and dividing it by the height.

Instead of an estimator 84, the driver 80 may comprise a Fourier calculator, calculating the discrete frequency component |c₁|² by calculating the FFT and checking the coefficient corresponding to f=L/T₀, and providing the result to the controller 82. In this case, the controller 82 is designed to vary L and to set L at such value where |c₁|² sufficiently low.

Alternatively, instead of the estimator 84, the driver 80 may comprise a correlator designed to correlate the instantaneous power to a reference signal (at frequency f=L/T₀ for the first harmonic) and providing the result to the controller 82. In this case, the controller 82 is designed to vary L and to set L at such value where said result is minimized.

Summarizing, the present invention provides a method for driving a gas discharge lamp 11 with commutating lamp current, wherein the lamp current has an average commutation frequency 1/T₀, the lamp current preferably having constant magnitude. In order to counteract the excitation of acoustic resonances, the phase φ_{C} of the commutation moments is randomly modulated. As a result, the discrete frequency components in the lamp power are less numerous, at higher frequency, and weaker. Thus, the risk of lamp resonance is reduced.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, in practice it may happen that X=1 for a certain time cell where X was equal to L for the immediately previous time cell. This would correspond to two commutations immediately following each other, which is not preferred. In order to avoid this situation, it is possible to define that the controller 42 always at least applies a minimum delay t_{DELAY,min}=Δ. It is also possible to never use the last time segment, corresponding to the phase signal X indicating an integer in the range [1;L−1]. It is also possible to never use the first time segment, corresponding to the phase signal X indicating an integer in the range [2;L]. It is also possible to do both, corresponding to the phase signal X indicating an integer in the range [2;L−1].

Further, although the driver 40 of FIG. 4 is shown as a half-bridge, the present invention can be implemented with any kind of commutator topology, such as for instance a full-bridge topology.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for driving a gas discharge lamp (11) with commutating lamp current, wherein the lamp current has an average commutation frequency (1/T0); the method comprising the step of randomly modulating the phase (φC) of the commutation moments.

2. Method according to claim 1, the method comprising the steps of:
generating a lamp current;
subdividing time (t) into consecutive time cells of mutually equal duration (T0);
in each time cell, determining one commutation moment;
reversing the direction of the lamp current at the commutation moments;
wherein, in each time cell, the phase of the corresponding commutation moment is determined at random.

3. Method according to claim 2, wherein, in each time cell, the phase of the start of the corresponding commutation moment is determined to have a value selected at random from a continuous range between 0 and T0 td, wherein td indicates a duration of the commutation.

4. Method according to claim 3, further comprising the steps of:
receiving a phase signal (X) indicating the phase of the start of the corresponding commutation moment;
receiving a signal (SCL) indicating the start of a time cell;
waiting a delay time (tDELAY) until a moment having within said time cell a phase corresponding to the said phase signal (X), and then starting a commutation operation.

5. Method according to claim 2, further comprising the steps of:
subdividing the time cells into a plurality of L discrete cell segments with mutually equal duration Δ=T0/L, L being a predetermined integer;
in each time cell, randomly selecting one of said cell segments;
performing the commutation during this selected cell segment.

6. Method according to claim 5, wherein Δ=td, td indicating a duration of the commutation.

7. Method according to claim 5, further comprising the steps of:
receiving a phase signal (X) indicating number of the selected cell segment;
receiving a signal (SCL) indicating the start of a time cell;
waiting a delay time (tDELAY) until reaching the start of the selected cell segment, and then starting a commutation operation.

8. Method according to claim 5 wherein, if in a certain time cell the last cell segment is selected for commutation, selection of the first cell segment in the next time cell is prevented.

9. Method according to claim 5, wherein selection of the last cell segment of the time cells is prevented.

10. Method according to claim 5, wherein L is calculated according to L=T0/Tcomm, wherein <Tcomm> is an estimate of the commutation duration.

11. Method according to claim 10, wherein <Tcomm> is estimated by monitoring commutation dips in the lamp power (P) and determining the width of the commutation dips at the half height thereof.

12. Method according to claim 10, wherein <Tcomm> is estimated by monitoring commutation dips in the lamp power (P), determining the area of the commutation dips, and dividing this area by the height of the commutation dips.

13. Method according to claim 5, wherein L is varied, wherein the effect of the variation on the energy spectrum is monitored, and wherein L is set to a value resulting in an optimum energy spectrum.

14. Method according to claim 13, wherein the lamp power (P) is monitored, wherein a fast Fourier transformation of the lamp power (P) is calculated, wherein the Fourier coefficient corresponding to f=L/T0 is determined, and wherein L is set such that this Fourier coefficient is minimal.

15. Method according to claim 13, wherein the lamp power (P) is monitored, wherein the lamp power (P) is correlated to a reference signal at frequency f=L/T0, and wherein L is set such that the correlation result is minimal.

16. Method according to claim 1, wherein the current has a substantially constant magnitude.

17. Method according to claim 1, wherein the commutation frequency (1/T0) has a value in the range from 9 kHz to 1 MHz.

18. (canceled)

19. Lamp driver for driving a gas discharge lamp, the lamp driver having a half-bridge topology with two controllable switches (M1, M2) arranged in series, the lamp being coupled to the node between said two switches, and the lamp driver further comprising a controller (42) controlling the switching of the said two switches; wherein the lamp driver is designed to perform a method according to claim 1.

20. Lamp driver according to claim 19, further comprising a random generator (43) and a phase modulator (44) associated with the controller (42).

21. Lamp driver according to claim 19, further comprising a clock signal generator (45) associated with the controller (42).

22. Lamp driver according to claim 19, having half-bridge commutating forward topology.

23. Lamp driver according to claim 19, further comprising estimating means (84) for estimating a value <Tcomm> of the duration of the commutation dips, and calculating means for calculating T0/<Tcomm>.

24. Lamp driver according to claim 19, further comprising a Fourier calculator for calculating the discrete frequency components of the energy spectrum of the commutation dips.
